(19) United States
(12) Patent Application Publication
(10) Pub. No.: US 2014/0202565 A1
(43) Pub. Date: Jul. 24, 2014

(54) MODULAR COMMUNITY WATER STATION

(71) Applicant: WARM SPRING FOUNDATION, Laguna Niguel, CA (US)

(72) Inventor: Erin J. BITTNER, Laguna Niguel, CA (US)

(73) Assignee: Warm Spring Foundation, Laguna Niguel, CA (US)

(21) Appl. No.: 13/746,832

(22) Filed: Jan. 22, 2013

(51) Int. Cl. C02F 1/00; F17D 1/00

(52) U.S. Cl. CPC C02F 1/006; F17D 1/00
USPC 137/561 R; 210/175; 210/153

(57) ABSTRACT

A deployable water management unit is disclosed that includes a fixture configured to be secured along an outer surface of a container in fluid communication with a water outlet port. In some embodiments, a water purifier may be positioned within an inner volume of a container and disposed along a water flow path between a water inlet port and a water outlet port. The water purifier may be configured to increase the temperature of inlet water to a preferred temperature. In still other embodiments, a plurality of interfaces may be configured to couple a panel to an outer surface of a container. The systems of the present disclosure may reduce the prevalence of disease associated with sanitation in various communities around the world. Further, the systems may heat water to provide a more enjoyable washing experience thereby encouraging a local community to engage in regular personal hygiene.

### BACKGROUND

Various communities around the world lack access to sale drinking water and sanitation systems. Such communities include groups of people located in remote areas, military training or combat environments, mining sites, natural disaster areas, or still other environments. In these or other locations, unprocessed water may contain various pathogens and particulates that are harmful to humans. Moreover, human waste that is not properly disposed of may seep into local ground water supplies, taint area wells, and may be ingested through physical contact. Local communities drinking contaminated water may experience shorter life expectancies and a lower quality of life. So prevalent is the issue of unsafe drinking water and sanitation systems that millions of people die each year due to diseases linked with inadequate waste water management.

A sanitation infrastructure is standard practice in developed countries but is not as prevalent in various communities around the world. Indeed, portions of Central and South America, South East Asia, India, and Africa lack access even to the most rudimentary sanitation devices, such as pit toilets or latrines. In these communities, human waste may flow along village streets after local disposal (e.g., within the village, within each house, etc.). Human waste may then pollute the local water supply indirectly where, by way of example, the waste seeps through the ground into the local water table. Human waste may also directly pollute a water supply where the waste is discarded of flows into a lake, river, or other body of water that serves as the local water supply. While this discussion has emphasized the prevalence of pollution occurring within a community, it should be understood that a community may also incidentally pollute the water supply of another community. Such incidental pollution may occur where, by way of example, one community discards human waste into a water supply that is shared with another community.

Humanitarian efforts have traditionally improved local sanitation through education and construction of lined pit toilets. Foremost, education of people living in remote communities may include instruction that water from a particular source is unsafe for human consumption or use. Where a body of water is a primary lifeline of the community, even education may not adequately protect the local population. In addition to education, aid organizations have constructed lined pit toilets in communities throughout the world. However, some communities around the world lack Western acceptance of entering a building and utilizing pit toilets, while at the same time, social norms prevent usage of toilets with insufficient privacy or security. Various additional factors (e.g., theft, damage by humans, damage by animals, etc.) may undermine the effectiveness of the pit toilet facility.

Along with sanitation, water quality affects communities around the world. Water treatment is the process of purifying water to convert unsafe water into water that is suitable for human consumption or use. One traditional purification process includes flowing water through filters (e.g., a filter comprising a fibrous material, a sand filter, a charcoal filter, etc.) to reduce the prevalence of particulates within the water. The unpurified water may be pumped through the filter under pressure or gravity fed through the filter material. However, filtering may not sufficiently reduce the prevalence of pathogens within water.

One traditional method of reducing the prevalence of pathogens within water includes adding various chemicals. Such chemicals may have certain properties that kill bacteria without adversely affecting human consumers of the treated water. In many instances, water purification chemicals are shipped to a remote community and mixed with untreated water to render the water suitable for human consumption or use. However, because the chemicals are mixed with the water, additional chemicals must be provided to allow for additional water purification. Other traditional systems for purifying water include boiling or evaporating a volume of water. However, boiling and evaporation systems either require extensive amounts of energy or are not efficient. Due to these deficiencies, a need exists for a modular sanitation and water treatment solution that is self-contained and self-powered.

### SUMMARY

One exemplary embodiment relates to a deployable water management unit that includes a container having a plurality of walls that define an inner volume and an outer surface. The plurality of walls further defines a water inlet port and a water outlet port. The unit also includes a piping system disposed within the inner volume, the piping system defining a water flow path between the water inlet port and the water outlet port, and a fixture configured to be secured along the outer surface of the container and in fluid communication with the water outlet port.

Another exemplary embodiment relates to a modular water purification system including a container having a plurality of walls that define an inner volume and an outer surface. The plurality of walls further defines a water inlet port and a water outlet port. The system also includes a piping system disposed within the inner volume, the piping system defining a water flow path between the water inlet port and the water outlet port, and a water purifier positioned within the inner volume of the container and disposed along the water flow path between the water inlet port and the water outlet port. The water purifier is configured to increase the temperature of water received through the water inlet port to a temperature of at least 73.9 degrees Celsius.

Still another exemplary embodiment relates to a system for managing water to improve community health that includes a container having a plurality of walls that define an inner volume and an outer surface. The plurality of walls further defines a water inlet port and a water outlet port. The system also includes a piping system disposed within the inner volume, the piping system defining a water flow path between the water inlet port and the water outlet port, a fixture configured to be secured along the outer surface of the container and in fluid communication with the water outlet port, and a plurality of interfaces configured to couple a panel to the outer surface of the container.

The invention is capable of other embodiments and of being carried out in various ways. Alternative exemplary embodiments relate to other features and combinations of features as may be generally recited in the claims.

### BRIEF DESCRIPTION OF THE FIGURES

The invention will become more fully understood from the following detailed description taken in conjunction with the accompanying drawings wherein like reference numerals refer to like elements, in which:

FIG. 1 is an elevation view of a container deployed on a ground surface, according to an exemplary embodiment.

FIG. 2 is an elevation view of a container including a pump, according to an exemplary embodiment.

FIG. 3 is an elevation view of a container including a pump and a heater, according to an exemplary embodiment.

FIG. 4 is an elevation view of a container including a pump, a heater, and an internal fuel storage tank, according to an exemplary embodiment.

FIG. 5 is a schematic view of a community water center, according to an exemplary embodiment.

FIG. 6 is a schematic view of a purification system, according to an exemplary embodiment.

FIG. 7 is a schematic view of a community water center, according to an exemplary embodiment.

FIG. 8 is an elevation view of a community water center configured to engage a leach field, according to an exemplary embodiment.

FIG. 9 is an elevation view of a community water center having a plurality of panels coupled to a container, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Modular community water centers may reduce the prevalence of disease associated with sanitation in various communities around the world. Such centers may also be installed more easily relative to traditional sanitation systems (e.g., pit toilets, etc.), which often require excavation or extraction of the waste material after extended use. Further, modular community water centers may be configured to provide permanent sanitation facilities, drinking water, warm water, electrical power, or still other services to a community. The community water centers may also include, by way of example, food, fuel, towels, toilet paper, flashlights, or other humanitarian goods.

While traditional systems for providing clean drinking water within a community rely on a source of purified water, the system of the present Application may, in some embodiments, purify water and also serve as a secured distribution point for the purified water. Such purification may include at least one of filtering, treating, and heating the water to a specified temperature. Applicant has determined that purification through filtering, treating, and heating requires less energy than traditional boiling techniques, reduces the need to resupply chemical additives utilized to chemically purify water, and provides a greater volume of treated water per unit of time than evaporative processes.

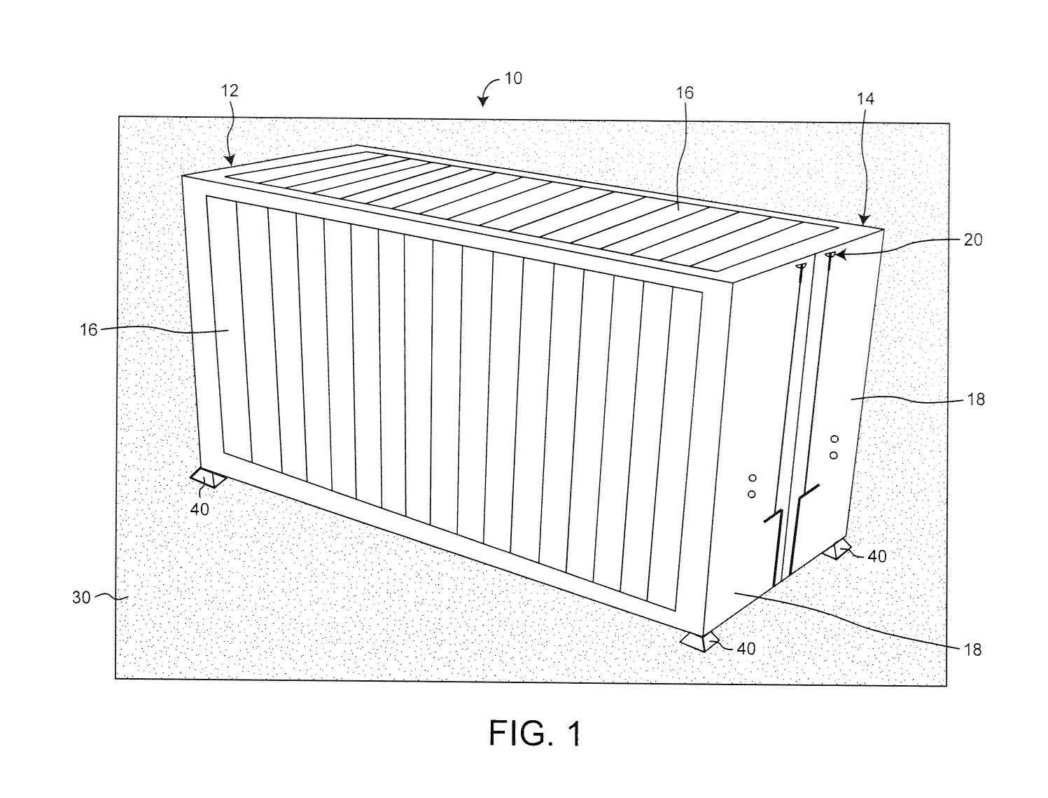

Referring now to FIG. 1, a community water center is shown, according to an exemplary embodiment. In some embodiments, the community water center may be partially pre-assembled and shipped to a target location. As shown in FIG. 1, a container (i.e. freight container, ISO container, shipping container, hi-cube container, box, CONEX box, sea can, etc.), shown as container 10, provides structural support for the community water center. The strength and structural rigidity of the container may allow several containers to be stacked atop one another (e.g., to facilitate shipping or transportation, to create a multi-level community water center, etc.). In some embodiments, container 10 may be a recycled shipping container, such as one commonly utilized aboard ocean-going vessels. In other embodiments, container 10 comprises a railroad car, a semi-truck trailer, or another suitable device.

Referring still to the exemplary embodiment shown in FIG. 1, container 10 is a shipping container having a first end, shown as distal end 12 and a second end, shown as proximate end 14. According to an exemplary embodiment, container 10 has a length of 20 feet. According to an alternative embodiment, container 10 has a length of 40 feet or another suitable length. In some embodiments, container 10 includes a plurality of walls, shown as panels 16 arranged as a rectangular box. In other embodiments, container 10 may include more or fewer walls that may be arranged in another configuration. According to an exemplary embodiment, panels 16 of container 10 define an outer surface and an inner volume. The inner volume may be partially or entirely enclosed within the footprint of container 10. The outer surface may be exposed to weather conditions or may itself be at least partially enclosed by another structure (e.g., a roof, a panel, etc.).

As shown in FIG. 1, container 10 includes access points, shown as doors 18. In some embodiments, doors 18 facilitate the operation of the community water center by allowing an operator to access the inner volume of container 10. According to the exemplary embodiment shown in FIG. 1, container 10 includes two doors 18 extending vertically along a face of proximate end 14. In other embodiments, container 10 may include more or fewer doors 18, doors 18 may be positioned along another portion of container 10 (e.g., along another sidewall, along an upper face, etc.), or doors 18 may extend laterally along the face of proximate end 14. As shown in FIG. 1, doors 18 include a plurality of hinges configured to allow each door panel of doors 18 to rotate about a vertical axis. In other embodiments, the door panels of doors 18 may slide, rotate, roll, or may be otherwise movable to provide access to the inner volume of container 10.

According to an exemplary embodiment, container 10 also includes a locking mechanism, shown as lock 20. Lock 20 may be configured to restrain the movement of doors 18 to at least partially secure the inner volume of container 10 thereby producing a tamper-proof system. In some embodiments, lock 20 secures within container 10 supplies and technology that may be potentially hazardous, valuable, or critical to the operation of the community water center. Such a lock 20 may be especially important where theft of items stored either within the internal volume of container 10 or along the outer surface of container 10 may occur. As shown in FIG. 1, lock 20 comprises a plurality of bars that extend upward upon engagement of a lever. Lock 20 may alternatively comprise another latch mechanism, a catch mechanism, or another type of system configured to restrain the movement of doors 18. In some embodiments, lock 20 includes a device (e.g., deadbolt, keyed connection, padlock, etc.) that must be actuated using a key or passcode.

Referring again to the exemplary embodiment shown in FIG. 1, container 10 is supported above a surface, shown as ground surface 30, with a plurality of supports, shown as footings 40. As shown in FIG. 1, each footing 40 comprises a concrete structure that includes a body having a tetrahedral shape. The body includes a bottom portion extending toward an upper portion. The bottom portion may have a cross sectional area that is larger than the cross sectional area of the upper portion. According to an alternative embodiment, footing 40 comprises another shape (e.g., block, cylindrical, irregular, etc.) that includes flat upper and lower surfaces. In some embodiments, footing 40 is coupled to container 10 with a fastener. By way of example, footing 40 may include a threaded shaft (e.g., threaded rod, bolt, etc.) coupled to (e.g., adhesively secured, embedded within, etc.) the body. A portion of the threaded shaft may be configured to interface with a fastener (e.g., washers and a threaded nut, etc.) positioned within the inner volume of container 10 to secure footing 40. Such a configuration may reduce the likelihood that an unauthorized person will reposition container 10 because the fasteners securing footings 40 are accessible only from within the secured inner volume of container 10.

According to an exemplary embodiment, footings 40 elevate container 10 from ground surface 30 to, by way of example, reduce the likelihood that moisture from ground surface 30 will damage container 10 (e.g., due to oxidation, etc.). According to an exemplary embodiment, footings 40 have a fixed length. According to an alternative embodiment, footings 40 are extendable. In either embodiment, footings 40 may be configured and positioned such that container 10 is not twisted (i.e. various footings 40 may be stacked or extended to level container 10 on uneven terrain).

According to an exemplary embodiment, a community water center may include a water pump configured to flow water through the container. Such a water pump may be operated using various sources of energy (e.g., electricity, a fossil fuel, human power, etc.). In some embodiments, the water pump may flow water from an underground water table. In other embodiments, the water pump may flow water from a ground level water source, such as a lake, river, or other body of water. In still other alternative embodiments, the water pump may flow water from a water storage system. The water pump may be located within the inner volume of the container or may be positioned in another location.

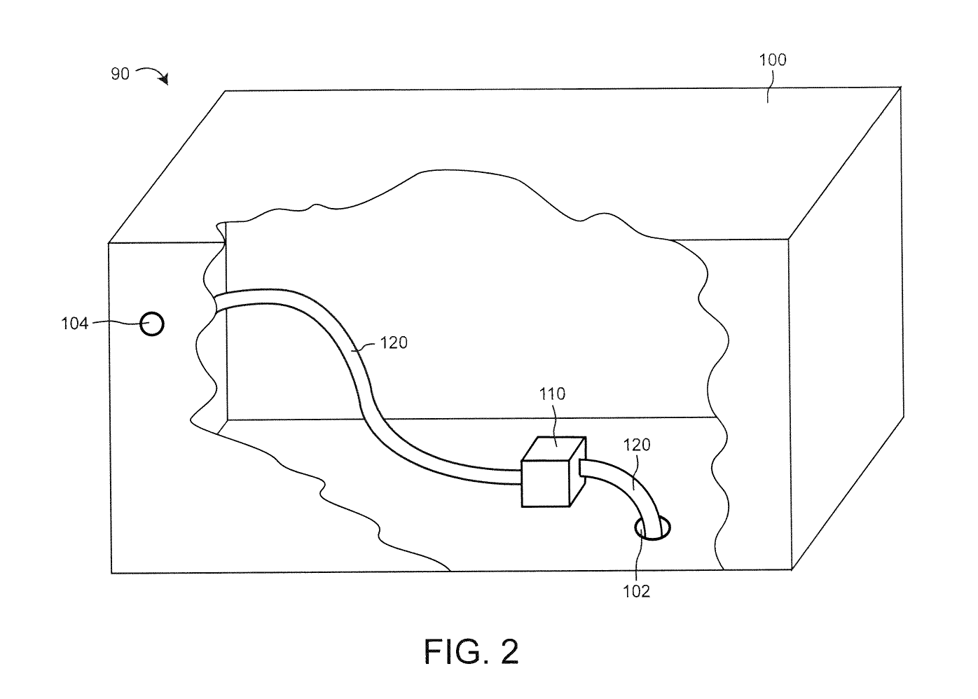

As shown in FIG. 2, a community water center, shown as community water center 90, includes a flow device, shown as pump 110 positioned within an inner volume of a container, shown as container 100. According to an exemplary embodiment, pump 110 is a piston pump. According to an alternative embodiment, pump 110 is another type of pump (e.g., centrifugal, etc.). As shown in FIG. 2, container 100 defines a plurality of apertures including an inlet (i.e. inlet port, etc.), shown as inlet 102 and an outlet (i.e. outlet port, etc.), shown as outlet 104. According to an exemplary embodiment, inlet 102 and outlet 104 comprise fittings configured to allow a fluid (e.g., water, effluent, etc.) to flow through without otherwise allowing access to an inner volume of container 100. According to an alternative embodiment, inlet 102 and outlet 104 comprise apertures that allow another system (e.g., hose, fitting, etc.) to extend through a wall of container 100. In either embodiment, inlet 102 and outlet 104 may be selectively sealed with a plug (e.g., a rubber disk configured to engage the walls of container 100, a stopper inserted into a fitting of inlet 102 or outlet 104, etc.) to prevent debris from entering container 100, by way of example, during transportation of container 100.

Referring still to the exemplary embodiment shown in FIG. 2, community water center 90 includes a piping system, shown as hoses 120 that couple pump 110 to inlet 102 and outlet 104. In some embodiments, hoses 120 engage a fitting at inlet 102 and outlet 104. In alternative embodiments, hoses 120 extend through a wall of container 100 to interface with various components outside container 100. According to an exemplary embodiment, pump 110 is configured to flow water from a water source through inlet 102, hoses 120, and outlet 104. It should be understood that while shown as flexible hoses, the piping system may alternatively comprise rigid tubular structures. As discussed above, pump 110 may be positioned outside of container 100 but remain in fluid communication with the piping system to flow water through inlet 102 and outlet 104.

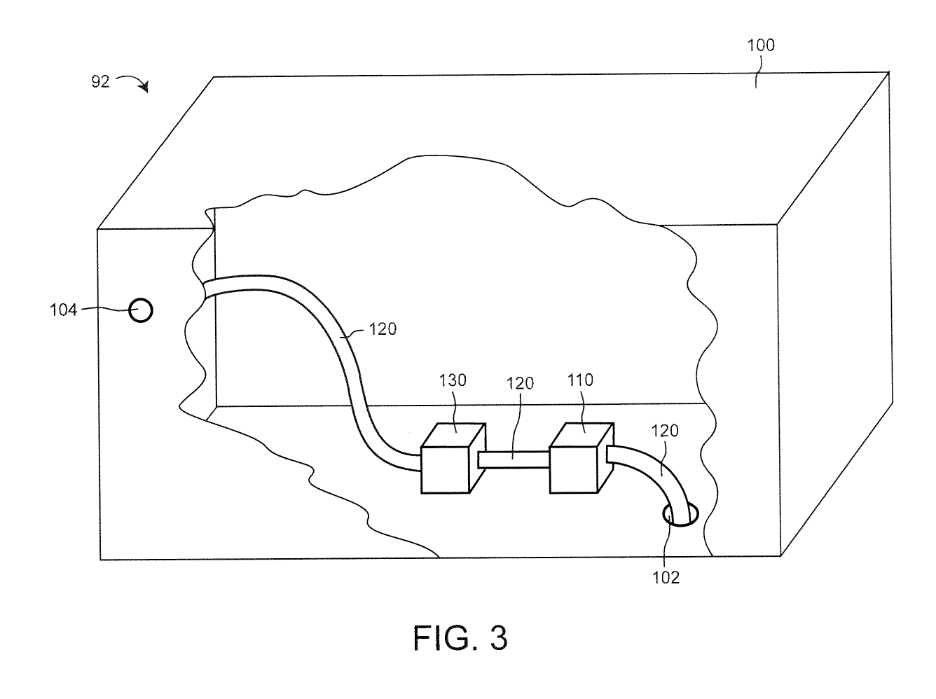

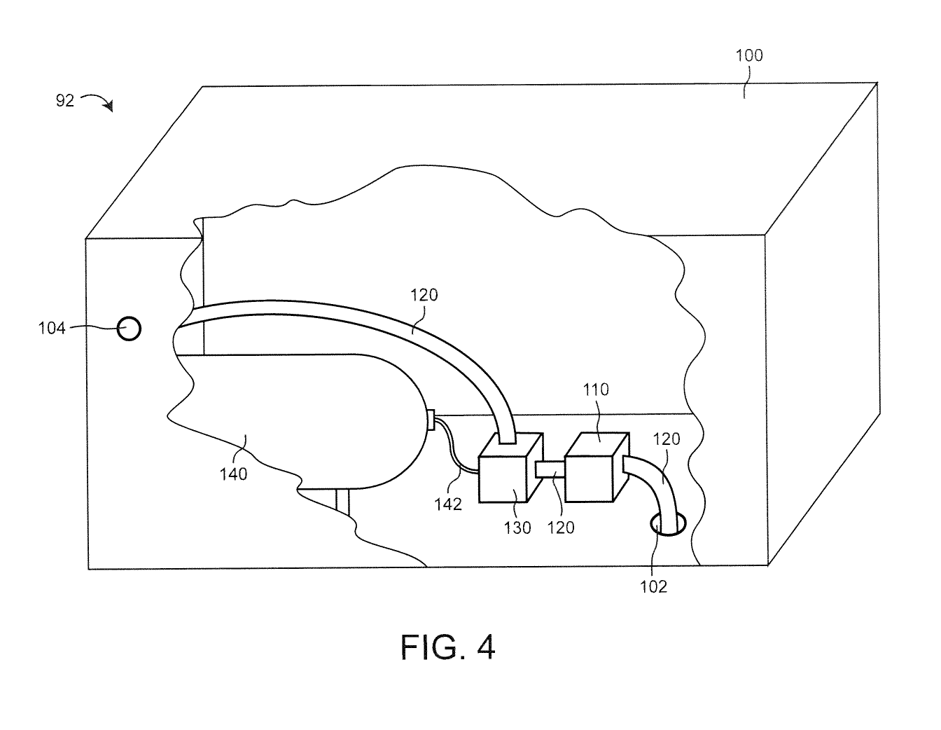

Referring next to the exemplary embodiment shown in FIGS. 3-4, a community water center, shown as community water center 92, is configured to heat water. The community water center 92 includes a container 100 defining an inner volume and a water heater, shown as heater 130 positioned within the inner volume. According to an exemplary embodiment, temperature controls for heater 130 are positioned within the inner volume of container 100, and container 100 includes a locking mechanism. Such a configuration may allow only a technician, or another person having access to the inner volume of container 100, to alter the output water temperature of heater 130. In some embodiments, water may be heated to provide a more enjoyable experience for a local community who may utilize community water center 92. Such a heated water supply may encourage a local community to engage in personal hygiene by washing regularly.

As shown in FIGS. 3-4, the community water center 92 includes pump 110 and hoses 120. In some embodiments, heater 130 may comprise a tankless water heater configured to heat water on an “as needed” basis thereby reducing the amount of energy needed to operate community water center 92. According to an alternative embodiment, heater 130 comprises a traditional tank-style water heater having a tank for storing water and a burner configured to heat the water to a predetermined temperature. In some embodiments, the community water center may include a plurality of heaters 130 to, by way of example, provide redundancy or increase the capacity of the system.

Tankless water heaters offer various benefits relative to traditional tank-style water heaters or other primary heating systems. Foremost, tankless water heaters are smaller and provide an endless, zero recovery time, heated water supply (e.g., up to 185 degrees Fahrenheit or 85 degrees Celsius) provided they have sufficient power and fuel, whereas tank-style water heaters are generally larger and have a slow recovery rate. Further, tankless water heaters include the ability to utilize smart technology such as microcontrollers, electronic thermostats, and interior aquastats that adjust the throughput flow volume to provide an outlet water flow having a desired temperature. The smart technology may also cascade a bank of several heaters to conserve fuel, increase hot water production capacity, and offer redundancy. Tankless water heaters also provide the flexibility to operate using various energy sources (e.g., propane, natural gas, biogas, syngas, electricity, etc.); provide the ability to operate at high altitudes; include heat exchangers that can be easily flushed to remove scale that may accumulate and impact efficiency; reduce the risk that water heater tanks will leak large amounts of water into the container; and conserve fuel by adapting quickly to changes in inlet water temperature. Applicant has determined that these and still other features make tankless water heaters especially suitable for community water centers receiving untreated water (i.e. water that has not been highly treated through a municipal water system, such as one of the systems common in developed nations) to, by way of example, remove salts, particulates, and pathogens. Various other benefits of tankless water heaters listed above are independent of whether the inlet water was previously treated.

As shown in FIG. 4, heater 130 exposes water to a flame generated by burning propane to generate a heated water flow. In some embodiments, the temperature of the heated water flow may be between 102 and 105 degrees Fahrenheit (between 38.9 and 40.6 degrees Celsius). Such temperature of the heated water flow may be predetermined by the manufacturer of community water center 92 or may be selectively determined by a technician (e.g., by changing a setting of heater 130).

Referring still to FIG. 4, heater 130 produces the heated water flow by burning propane provided to heater 130 from a storage volume, shown as fuel tank 140. According to an exemplary embodiment, fuel tank 140 is configured to store propane. In the embodiment shown in FIG. 4, fuel tank 140 is positioned within the inner volume of container 100. Such a configuration may secure fuel tank 140 within container 100 to prevent, by way of example, theft of fuel from fuel tank 140 or damage to fuel tank 140 (e.g., due to animals, etc.). According to an exemplary embodiment, fuel tank 140 is coupled to heater 130 with a line, shown as line 142. While not explicitly shown in FIG. 4, it should be understood that fuel tank 140 may include various valves, regulators, indicators, ports, or other components commonly associated with propane or natural gas storage systems. While shown positioned within the internal volume of container 100, any of pump 110, heater 130, and fuel tank 140 may be positioned outside container 100.

According to an exemplary embodiment, the community water center also includes a water outlet device (e.g., fixture, showerhead, spigot, etc.) configured to be secured (i.e. fastened, releasably attached, etc.) along an outer surface of the container. Such an outlet device may be in communication with the outlet port and allow water to flow from the container for use by a user. According to an exemplary embodiment, the outlet device is a shower head positioned such that a user may practice basic cleanliness without needing to enter the container. Applicant has determined that various communities may be more accepting of basic hygiene practices (e.g., hand washing, showering, etc.) where water is supplied at a preferred temperature (e.g., heated water, cooled water, etc.). Moreover, various communities around the world are apprehensive to enter an enclosed space due to, as they believe, the presence of evil spirits within the buildings. The system of the present Application allows for hygiene practices to occur without requiring the user to enter the container thereby improving safety and increasing the likelihood that local communities will utilize the community water center.

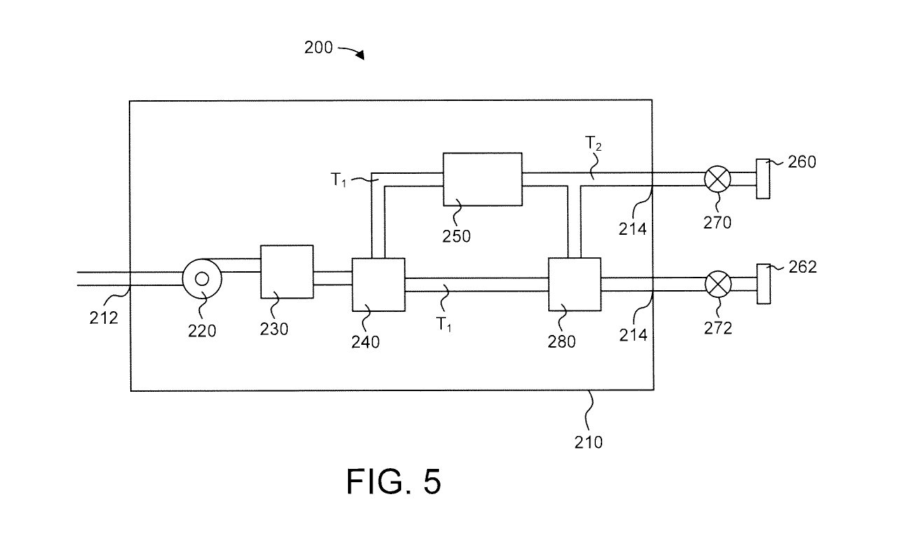

Referring next to the exemplary embodiment shown in FIG. 5, a community water center, shown as community water center 200 is designed to purify water for human consumption or use. As shown in FIG. 5, community water center 200 includes a container, shown as container 210 that defines an inlet, shown as inlet 212 and at least one outlet, shown as outlet 214. As discussed above, container 210 may secure various components of community water center 200 (e.g., to prevent theft, damage, etc.). According to an exemplary embodiment, community water center 200 includes a pump 220 configured to flow water from a water source (e.g., lake, river, well, etc.) into container 210 through inlet 212 thereby creating an inlet water flow. As shown in FIG. 5, community water center 200 also includes a filter, shown as filter 230 and a heater, shown as heater 240. In some embodiments, water is flowed by pump 220 through filter 230 and into heater 240.

According to an exemplary embodiment, heater 240 is configured to increase the temperature of the inlet water flow from an initial temperature T₀ to a temperature T₁, the difference between T₀ and T₁ defining a ΔT. Applicant has determined that heating water to a preferred temperature will reduce the prevalence of various microorganisms, bacteria, or viruses. Such a preferred temperature may vary depending on the types of bacteria found within a local water source, the desired inactivation percentage, and the exposure time (i.e. the period of time that the water will be kept at a certain temperature). By way of example, an exposure time of one minute will inactivate ninety percent of microbes for the following bacteria at the following temperature values: 131 degrees Fahrenheit (55 degrees Celsius) for worms and cysts of Giardia, Cryptosporidium, and Entamoeba; 140 degrees Fahrenheit (60 degrees Celsius) for Vibrio cholerae, E. coli, Shigella sp, Salmonella typhi, and Rotavirus; and 149 degrees Fahrenheit (65 degrees Celsius) for Hepatitis A virus. However, a temperature of between 160 and 167 degrees Fahrenheit (between 71.1 and 75 degrees Celsius) may be utilized with an exposure time of between fifteen and thirty seconds to reduce the prevalence of these and other microbes. The minimum requisite exposure time may vary based on the preferred heating temperature and the desired inactivation percentage. Community water center 200 may include various piping systems, storage tanks, supplemental heating systems, or heat exchangers to facilitate heating the water to the aforementioned temperatures for one minute. In other embodiments, heater 240 may heat the water to a temperature T₁ that is greater than the temperatures provided above such that the water, even if it cools after it flows from heater 240, is exposed to the preferred heating temperature for the minimum requisite exposure time.

Referring again to FIG. 5, community water center 200 includes a water tank, shown as tank 250, that is configured to receive at least a portion of the inlet water flow from heater 240. In some embodiments, tank 250 is configured to store a first heated water flow that is provided from heater 240. The first heated water flow stored within tank 250 may thereafter lose energy (e.g., to the air within container 210, to an outside environment, to a working fluid, to a heat exchanger configured to preheat inlet water flow before it enters heater 240, etc.) and decrease in temperature to provide a warm water flow having a temperature T₂. According to an exemplary embodiment, T₁ is between 160 and 212 degrees Fahrenheit (between 71.1 and 100 degrees Celsius) and T₂ is less than 160 degrees Fahrenheit (71.1 degrees Celsius).

In some embodiments, the warm water flow may be provided from tank 250 to other components of community water center 200. As shown in FIG. 5, the warm water flow is provided through outlet 214 and may be selectively discharged through a first fixture, shown as first fixture 260 with a first valve, shown as first valve 270. According to the exemplary embodiment shown in FIG. 5, heater 240 also provides a second heated water flow having a temperature T₁ to a valve, shown as mixing valve 280, where the second heated water flow interacts with a portion of the warm water flow from tank 250. According to an exemplary embodiment, mixing valve 280 comprises a valve similar to those utilized in traditional plumbing applications. Such a configuration produces an intermediate water flow having a temperature between T₁ and T₂. In some embodiments, mixing valve 280 includes at least two inlets, an outlet, and a control mechanism (e.g., handle, dial, etc.). According to an exemplary embodiment, the control mechanism allows a user (e.g., a technician, a person utilizing the water flow, etc.) to vary the temperature of intermediate water flow by varying the ratio of heated water flow to warm water flow. In other embodiments, mixing valve 280 may not include a control mechanism and may instead provide a fixed ratio of heated water flow to warm water flow. As shown in FIG. 5, the intermediate water flow is provided through a second outlet 214 and may be selectively discharged through a second fixture, shown as second fixture 262 with a second valve, shown as second valve 272.

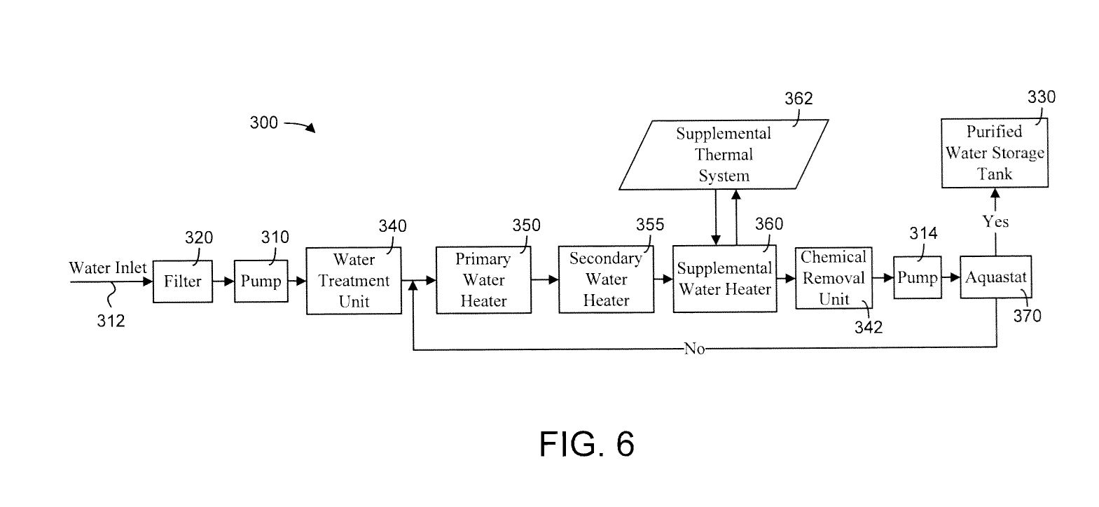

Referring next to the exemplary embodiment shown in FIG. 6, a purification system, shown as purification system 300 includes a piping system configured to convey water between various components. While shown schematically in FIG. 6, it should be understood that water purification system 300 may be at least partially incorporated within a container and may be configured to provide water to fixtures secured along the outer surface of the container. As shown in FIG. 6, water is drawn by a pump, shown as pump 310 from a water inlet (e.g., from a well, from a water tank, etc.), shown as water inlet 312, through a filter, shown as filter 320, and toward a purified water storage tank, shown as purified water storage tank 330. Such a system may provide clean drinking water to a community. A second pump, shown as pump 314, may be positioned downstream of the first pump to also draw water through various components of purification system 300. In some embodiments, filter 320 comprises a broad filter configured to reduce the prevalence of particulates. Thereafter, the water flows through a water treatment system, shown as water treatment unit 340. According to an exemplary embodiment, water treatment unit 340 is configured to soften, purify with chemicals or ultraviolet light, or otherwise treat the water flow. In some embodiments, water treatment unit 340 may reduce the prevalence of scaling within various components of purification system 300, may chemically purify the water flow, or may provide still other benefits. According to an exemplary embodiment, purification system 300 also includes a chemical removal system, shown as chemical removal unit 342 that is configured to remove various chemicals, such as those used to prevent scaling, from the water flow prior to storage. In other embodiments, purification system 300 may not include water treatment unit 340 or chemical removal unit 342.

Referring still to the exemplary embodiment shown in FIG. 6, purification system 300 includes a first water heater, shown as primary water heater 350, and a second water heater, shown as secondary water heater 355. In some embodiments both the primary water heater 350 and the secondary water heater 355 are tankless water heaters configured to heat the inlet water flow to a temperature of 165 degrees Fahrenheit (73.9 degrees Celsius) when turned “on.” According to an exemplary embodiment, primary water heater 350 is configured to throttle the flow rate of the water to ensure that water exiting primary water heater 350 reaches 165 degrees Fahrenheit (73.9 degrees Celsius). Secondary water heater 355 may be configured to supplement primary water heater 350 to, by way of example, increase the flow rate of heated water provided to the remainder of purification system 300. According to an alternative embodiment, secondary water heater 355 provides redundancy to the system or extends the period of time that the water flow is heated by purification system 300 (i.e. an exposure time may be increased to further purify the inlet water).

According to an exemplary embodiment, a supplemental water heater, shown as supplemental water heater 360, may be included to transfer additional thermal energy into the water flow. Such a supplemental water heater may provide various benefits such as reducing the fossil fuel required to operate purification system 300 or increasing the temperature or exposure time of the water during the purification process, among others. While shown in FIG. 6 positioned downstream of the primary water heater 350 and secondary water heater 355, supplemental water heater 360 may be positioned before, after, or between the primary water heater 350 and secondary water heater 355, according to various alternative embodiments. In some embodiments, supplemental water heater 360 includes a supplemental heater, shown as supplemental thermal system 362. According to an exemplary embodiment, supplemental thermal system 362 comprises a solar thermal unit configured to flow the water through an extended length of black plastic tubing positioned at least one of along an outer upper surface of a container and along the surrounding ground surface. Such a system may allow the water to absorb heat from the sun before entering the container. In other embodiments, supplemental thermal system 362 may comprise a piping system configured to expose the water flow to a flame from a biofuel heater, exhaust from a fossil fuel generator, exhaust from the primary and secondary water heater (350, 355), water stored within the purified water storage tank, or still another source.

After flowing through the water heaters, the water flow interfaces with an aquastat, shown as aquastat 370, according to an exemplary embodiment. As shown in FIG. 6, the aquastat is configured to allow water having a predetermined temperature (e.g., 165 degrees Fahrenheit or 73.9 degrees Celsius) to flow into purified water storage tank 330. Where the water flow has not reached the predetermined temperature, aquastat 370 may be configured to direct the water through the water heaters again, as shown schematically in FIG. 6. Such a purification system 300 including an aquastat 370 may reduce the risk that unpurified water (e.g., water that has not reached a sufficient temperature) will contaminate the purified water within purified water storage tank 330. Water that reaches the predetermined temperature flows into purified water storage tank 330 where it may subsequently cool to a lower temperature.

In some embodiments, the heated water within the purified water storage tank 330 may be cooled by a heat exchanger configured to preheat the cold, untreated inlet water. Such a heat exchanger may be configured to preheat the cold, untreated inlet water while still allowing the heated water to maintain the preferred heating temperature for the requisite exposure time. The use of a heat exchanger in this manner achieves several benefits. First, water must be heated to the preferred heating temperature to inactivate pathogens, but the resulting purified water may be too hot for direct use. Directly mixing the heated purified water with cold, untreated inlet water may reduce the temperature of the heated purified water but may reintroduce pathogens from the cold, untreated inlet water into the heated purified water thereby undermining the desired purification process. The heat exchanger may facilitate providing purified water at a preferred outlet temperature without compromising purity. Second, a heat exchanger reduces the amount of energy required to purify the preheated inlet water. According to an exemplary embodiment, the tankless water heater is configured to automatically throttle the consumption of energy (e.g., propane, electricity, etc.) based on the initial temperature of the untreated inlet water flow.

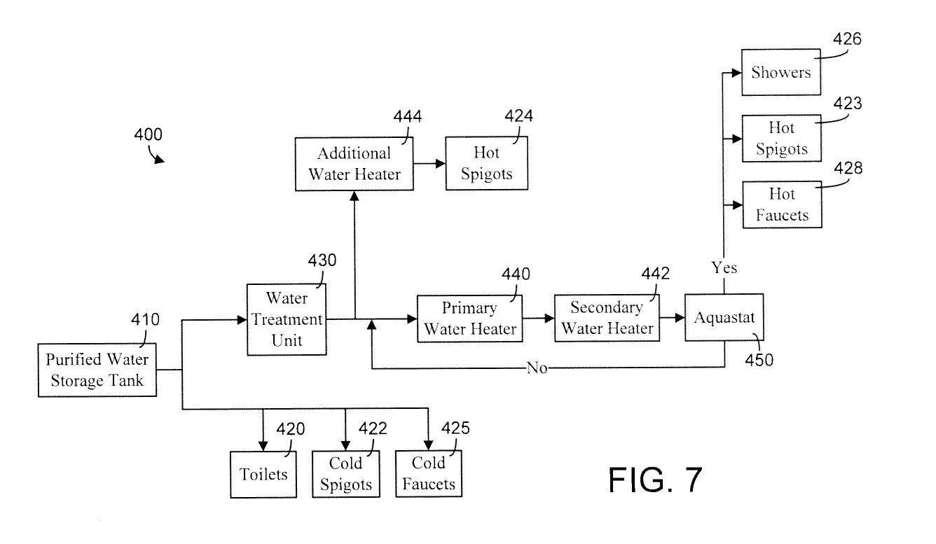

Referring next to the exemplary embodiment shown in FIG. 7, a community water center, shown as community water center 400, includes a purified water storage tank, shown as purified water storage tank 410. According to an exemplary embodiment, purified water storage tank 410 is located in an elevated position relative to other components of the community water center 400 to pressurize the water flow with a gravity head. In other alternative embodiments, community water center 400 may include a pump configured to flow the water through a piping system of the community water center 400. In either embodiment, water may flow from purified water storage tank 410 to a fixture after a user opens a valve (e.g., a flush valve of a toilet, a shower or spigot valve, etc.).

As shown in FIG. 7, community water center 400 include fixtures, shown as toilets 420, cold spigots 422, and cold faucets 425 configured to receive cold water from the purified water storage tank along a first water flow path. As used herein, “cold” and “hot” refer to a temperature of the identified water flow relative to the temperature of water flowing through other portions of the community water center. By way of example, where the temperature of the purified water within the purified water storage tank is 80 degrees Fahrenheit (26.7 degrees Celsius), the temperature of the water in toilets 420, cold spigots 422, and cold faucets 425 may be 80 degrees Fahrenheit (26.7 degrees Celsius).

Referring still to the exemplary embodiment shown in FIG. 7, a portion of the water from purified water storage tank 410 may flow through a water treatment system, shown as water treatment unit 430. In some embodiments, water treatment unit 430 is configured to treat the water flow to reduce the prevalence of scaling within various components of community water center 400. According to the exemplary embodiment shown in FIG. 7, a second water flow path is defined through a primary water heater, shown as primary water heater 440, a secondary water heater, shown as secondary water heater 442, an aquastat, shown as aquastat 450 and outward through various fixtures, shown as showers 426, hot spigots 423, and hot faucets 428. As discussed above, the primary and secondary water heaters (440, 442) may be tankless water heaters configured to heat the water flow to a predetermined temperature (e.g., 100 degrees Fahrenheit or 37.8 degrees Celsius). The primary water heater 440 may be activated after sensing a water flow or a decrease in downstream pressure, which occurs after a user opens a valve of a fixture. In some embodiments, aquastat 450 is configured to recirculate water that has not been heated to a preferred temperature (e.g., 100 degrees Fahrenheit or 37.8 degrees Celsius) to reduce users' exposure to cold water, as shown schematically in FIG. 7.

Secondary water heater 442 may provide redundancy or may supplement the heating capacity of the system where, by way of example, the heated flow demand is greater than the heating capacity of primary water heater 440. According to an exemplary embodiment, primary water heater 440 is coupled (e.g., with a data communication link) to secondary water heater 442. In some embodiments, secondary water heater 442 is configured to at least one of send and receive signals and may turn “on” automatically upon sensing additional demand to supplement the capacity of the primary water heater 440. Where both the primary and the secondary water heaters (440, 442) are “on,” after a preferred period of time, or after another condition occurs, secondary water heater 442 may function as the principal water heater (i.e. secondary water heater 442 may be turned “on” first) during the next duty cycle to, by way of example, harmonize wear and use of the primary and secondary water heaters (440, 442).

Referring again to the exemplary embodiment shown in FIG. 7, a third flow path is defined through an additional water heater, shown as additional water heater 444, and out through additional hot spigots, shown as hot spigots 424. Additional water heater 444 may comprise a tankless water heater configured to provide water through hot spigots 424 at a different temperature than the water provided by primary water heater 440 through hot spigot 423. By way of example, additional water heater 444 may be configured to heat the water flow to a predetermined temperature (e.g., 145 degrees Fahrenheit or 62.8 degrees Celsius). Such a water flow from additional water heater 444 may facilitate a user's ability to wash pans, wash clothing, or perform other cleaning tasks. While shown in FIG. 7 positioned before the primary and secondary water heaters (440, 442), additional water heater 444 may be positioned before, after, or between the primary and secondary water heaters (440, 442). According to an alternative embodiment, community water center 400 may not include aquastat 450, secondary water heater 442, additional water heater 444, may include some combination of the components shown in FIG. 7, or may include still other components (e.g., pumps, supplemental water heaters, etc.).

According to an alternative embodiment, used and previously treated water (i.e. “greywater”) from the spigots (422, 423, 424), showers 426, faucets (425, 428), or other fixtures may be recycled and utilized in another portion of community water center 400. By way of example, water may be collected from shower pans located below showers 426, pumped into a temporary holding tank, and thereafter provided through a piping system to toilets 420. According to an alternative embodiment, greywater may not be collected and instead may be provided directly to other fixtures (e.g., toilets 420, etc.) or out of the community washing station for still other uses. In either embodiment, the plumbing arrangement may allow a fixture (e.g., a toilet) to operate selectively with greywater when available, with raw untreated water, or with treated water that has not been previously used. In other embodiments, the greywater may be filtered, treated, or otherwise purified and provided to various fixtures of community water center 400.

According to still another alternative embodiment, a community water center may include still other arrangements of water heaters. Such water heaters may be set at a single temperature or at different temperatures. As discussed above, including several heaters all set at the same temperature may increase the volume of heated water flow produced during a period of time. Where the various heaters are set at different temperatures, a first subset of the heaters may be set at a first temperature (e.g., 165 degrees Fahrenheit or 73.9 degrees Celsius to purify water), and a second subset of the heaters may be set at a second temperature (e.g., between 102 and 105 degrees Fahrenheit or between 38.9 and 40.6 degrees Celsius to use for personal hygiene). According to still another alternative embodiment, a community water center may include additional systems configured to soften, chemically purify, or otherwise treat the water.

While this disclosure has described a particular configuration of components, it should be understood that a community water center may include more or fewer components or the components may be otherwise arranged, among other modifications. By way of example, several components (e.g., the water tank, the pump, etc.) may be positioned either within or outside the container. Such a configuration may allow for remote positioning of the pump (e.g., near a power supply) or the water tank (e.g., to allow for a greater storage volume).

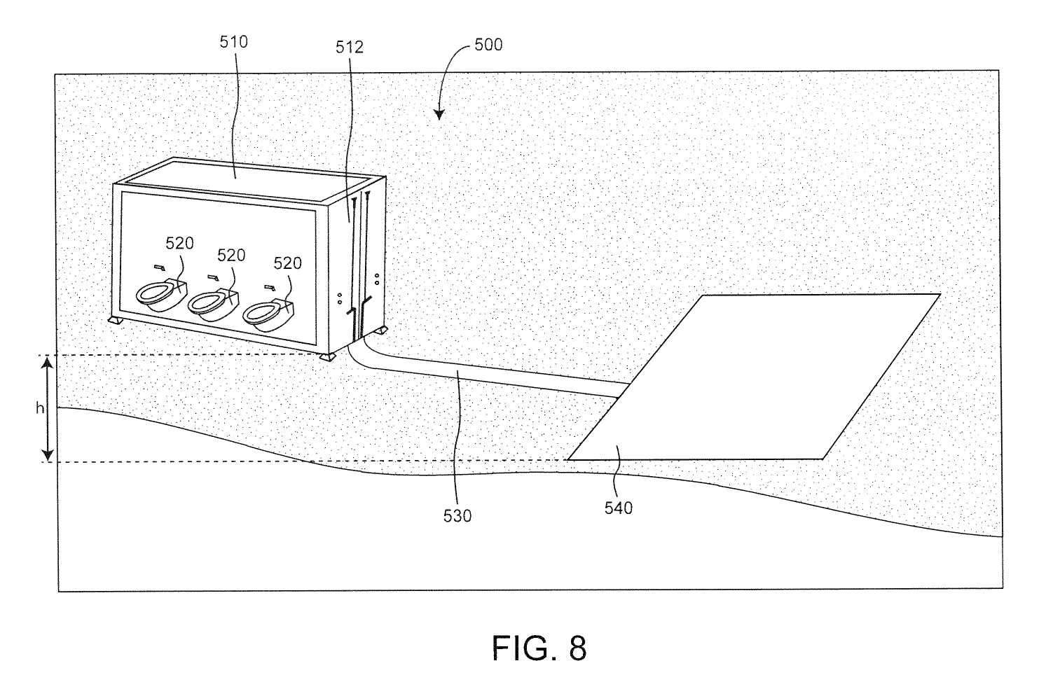

Referring next to the exemplary embodiment shown in FIG. 8, a community water center, shown as community water center 500 includes a container, shown as container 510. As shown in FIG. 8, container 510 is generally rectangular and includes a plurality of walls that define an inner volume and an outer surface. According to an exemplary embodiment, container 510 also includes a plurality of locking doors, shown as locking doors 512 configured to secure the inner volume of container 510. In some embodiments, the plurality of walls also defines at least one water outlet port and at least one waste return port. According to an exemplary embodiment, community water center 500 includes a plurality of fixtures (i.e. latrines, privies, water-less toilets, WCs, etc.), shown as toilets 520, secured along the outer surface of container 510. According to an alternative embodiment, community water center 500 includes other fixtures (e.g., showers, sinks, spigots, etc.).

Toilets 520 may be secured along the outer surface of container 510 with various known fastening systems (e.g., hex bolts, carriage bolts, rivets, etc.). In some embodiments, the fastening systems are configured to prevent theft or damage to toilets 520. By way of example, carriage bolts may extend from outside the container, through a mounting flange of toilets 520, and into the interior volume of container 510. A corresponding nut within the interior volume of container 510 may be tightened by a technician to secure toilets 520 along the outer surface of container 510. Such a fastening system may reduce the likelihood of theft or damage to toilets 520 because, by way of example, toilets 520 may be removed only by loosening the nuts located within the secured inner volume of container 510. According to an alternative embodiment, bolts may extend outward through the sidewall of container 510 and a mounting flange of toilets 520 to engage a nut. A configuration having the nut located outside of container 510 may allow for efficient installation or removal of toilets 520 where, by way of example, access to the interior volume of container 510 is difficult (e.g., the inner volume of container 510 is filled with the various components of community water center 500).

Referring still to the exemplary embodiment shown in FIG. 8, toilets 520 each engage a water outlet port that supplies water from within container 510 to fill toilets 520 with water. Toilets 520 may further each flow effluent to the interior volume of container 510 through corresponding waste return ports. It should be understood that, in some embodiments, users may selectively flush toilets 520 to replace the effluent with fresh water. In other embodiments, toilets 520 may flush automatically to, by way of example, prevent misuse of community water center 500.

According to an exemplary embodiment, various components of community water center 500 may be pre-assembled prior to shipping and deployment. By way of example, the various internal components positioned within container 510 during operation may be assembled in a “ready-to-use” arrangement. In some embodiments, a plumbing system, a pump, and a drain system may be assembled prior to deployment. Moreover, the various ports (e.g., inlet ports, outlet ports, waste return ports, etc.) of community water center 500 may be defined (e.g., cut, sliced, disposed, etc.) within the sidewalls of container 510 during the manufacturing process and prior to deployment of community water center 500. Where container 510 defines such ports, community water center 500 may also include a plurality of caps (i.e. covers, plugs, lids, stoppers, etc.) positioned over the ports to prevent debris from entering the plumbing system during transportation.

According to an exemplary embodiment, this arrangement of components defines a partially pre-assembled condition leaving few components that require assembly in the field prior to use. While several components may be assembled prior to deployment, toilets 520 may be initially provided within container 510 to facilitate transportation, according to an exemplary embodiment. Upon delivery, a technician may open locking doors 512 of container 510, remove toilets 520 from the interior volume of container 510, remove the various caps positioned over the ports, and secure toilets 520 along the outer surface of container 510.

According to an exemplary embodiment, a plumbing system of community water center 500 couples the various waste return ports into a central line. According to an exemplary embodiment, the central line is in fluid communication with a primary waste outlet defined within a wall of container 510. As shown in FIG. 8, community water center 500 also includes a transport tube, shown as tube 530. In some embodiments, an end of tube 530 is secured along the outer surface of container 510 in fluid communication with the primary waste outlet. As discussed above with respect to toilets 520, tube 530 may be provided within the inner volume of container 510 in a storage configuration (e.g., rolled, disassembled, etc.) during transportation and coupled to the outer surface of container 510 by a technician upon delivery. Coupling tube 530 to the primary waste outlet allows effluent from toilets 520 to travel through the plumbing system, into the central line, through the primary waste outlet, and into tube 530.

Referring still to the exemplary embodiment shown in FIG. 8, tube 530 extends along a ground surface to a septic drain field, shown as leach field 540. In some embodiments, tube 530 provides the effluent from toilets 520 directly to leach field 540. According to an alternative embodiment, community water center 500 includes a waste storage tank configured to receive the effluent from toilets 520 until the mixture is periodically transported (e.g., flowed due to gravity after a valve is opened, pumped, etc.) to leach field 540. According to still another alternative embodiment, the waste storage tank is configured to receive the effluent from the toilets 520, allow solid materials to settle, and continuously flow waste to leach field 540 (i.e. as additional volume is flowed into the waste storage tank, additional volume is flowed to leach field 540). According to an exemplary embodiment, the waste storage tank is positioned within the inner volume of container 510. According to an alternative embodiment, the waste storage tank is positioned outside container 510 either above or below a ground surface. According to still another alternative embodiment, the effluent from the toilets may be utilized to generate biogas (e.g., to supplement fossil fuels, to run a biogas heating unit, to provide biogas to the local community), may be routed to another type of modified septic system to reduce the pathogen burden on the leach field, or may provide a source of fertilizer. In still other alternative embodiments, greywater or effluent from the fixtures of community water center 500 may be directed toward vegetation (e.g., trees, etc.) to provide irrigation.

According to an exemplary embodiment, leach field 540 is located in a target area having preferred characteristics. Such preferred characteristics may include the amount of water that collects within the target area because flooding of the leach field may inhibit the use of community water center 500 by the community. As a further example, container 510 may be positioned along a ground surface at a higher elevation than leach field 540 such that the effluent may flow due to gravity from container 510 to leach field 540 along tube 530. As shown in FIG. 8, container 510 is positioned a vertical height, shown as height “h,” above leach field 540. According to an alternative embodiment, leach field 540 may be located at the same vertical height as container 510 or may be elevated with respect to container 510. In such embodiments, a fluid movement device (e.g., pump, etc.) may transport the effluent from container 510 to leach field 540.

In some embodiments, leach field 540 is positioned a lateral distance from container 510. By way of example, leach field 540 may be positioned 500 yards from container 510. In other embodiments, container 510 may be positioned proximate (i.e. less than twenty feet from, directly above, within, etc.) leach field 540. Where container 510 is positioned proximate leach field 540, tube 530 may have a decreased length or community water center 500 may not include tube 530 (i.e. water and waste material may flow directly into leach field 540).

According to an exemplary embodiment, leach field 540 comprises various layers of material designed to remove impurities and contaminants from the effluent. Such layers may include an upper top soil layer, a layer of sand material, and a layer of porous material (e.g., gravel, etc.). It should be understood that tube 530 may be coupled to one or more porous section of tube, such as weeping tile or perforated pipe, extending within leach field 540. According to an exemplary embodiment, effluent from toilets 520 is decomposed by microbes within leach field 540 below the ground surface. Such a configuration of a leach field 540 allows for the disposal of human waste without exposing members of the community to the effluent directly. Instead, the system shown in FIG. 8 is intended to meet the basic sanitation needs of the community while reducing the risk of disease.

As discussed above, various components may be provided within container 510, and container 510 may be deployed in a partially pre-assembled configuration. Because leach field 540 interacts with the surrounding ground volume, leach field 540 may be sited or constructed by a technician either before or after deployment of container 510. Siting or constructing leach field 540 in advance of deploying container 510 may reduce the time needed before a community may begin to utilize community water center 500 after delivery of container 510.

According to an alternative embodiment, container 510 may include various components configured to facilitate the siting or construction of leach field 540. Therefore, delaying siting or construction of leach field 540 until deployment of container 510 may allow a technician to receive various supplies designed to facilitate the siting or construction process. By way of example, container 510 may include various components that allow a technician to conduct a percolation test of a target area for the leach field 540. A percolation test evaluates whether the ground material is sufficiently fine to retain effluent until it decomposes while sufficiently course to allow effluent to percolate away from leach field 540. It should be understood that ground material that is too course may allow effluent to interact with and pollute a ground water supply or another water source. However, ground material that is too fine may allow leach field 540 to fill with effluent and prematurely limit the ability of the community to utilize community water center 500. According to an alternative embodiment, container 510 includes excavation equipment, components to construct leach field 540 (e.g., weeping tile, perforated pipe, sand, gravel, etc.), or still other materials.

While leach field 540 is schematically in FIG. 8 as a flat rectangle, it should be understood that leach field 540 may include various elements. According to an exemplary embodiment, leach field 540 includes a primary tube and a plurality of extension tubes. Such primary and extension tubes may be positioned within corresponding trenches (e.g., measuring two feet deep and two feet wide) below a ground surface. In other embodiments, leach field 540 may be otherwise shaped.

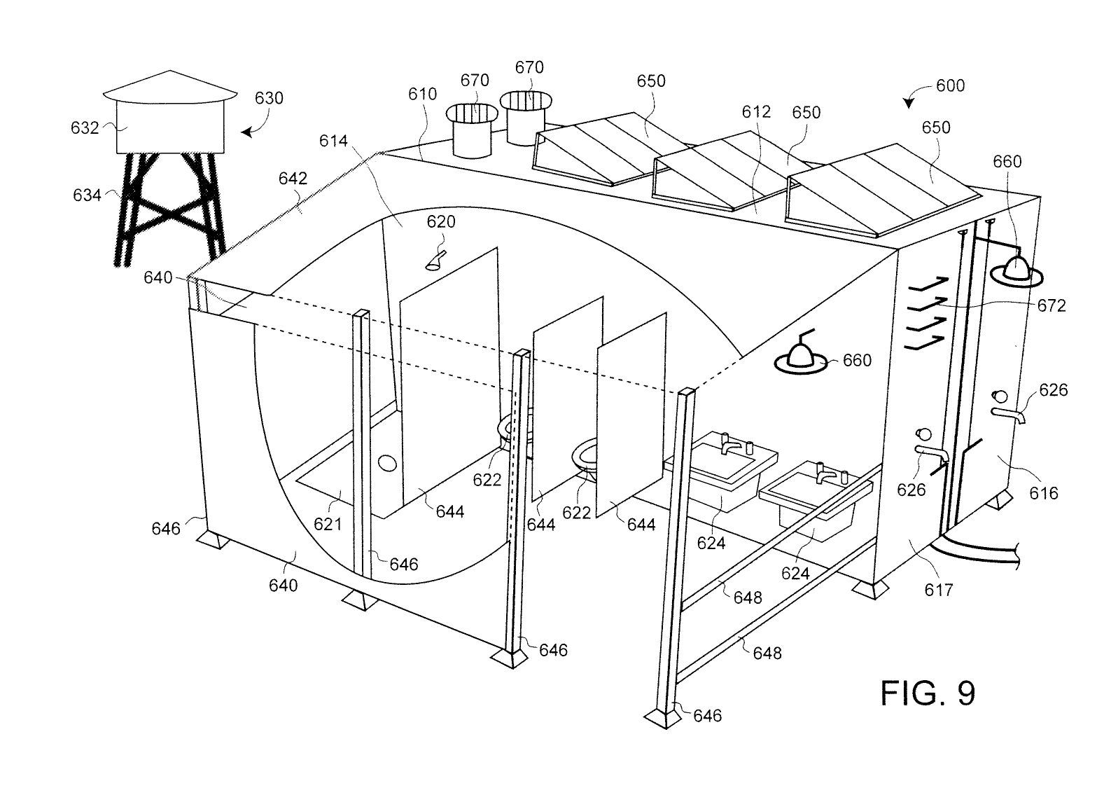

Referring next to the exemplary embodiment shown in FIG. 9, a community water center, shown as community water center 600 includes a primary structural member, shown as container 610. As shown in FIG. 9, container 610 includes an upper wall, shown as top wall 612, a sidewall, shown as sidewall 614, and a first and a second locking door, shown as locking doors 616, 617. In some embodiments, top wall 612, sidewalls 614, and locking doors 616, 617 define an inner volume and an outer surface. According to an alternative embodiment, container 610 may include a different configuration of wall elements or may include still another combination of faces.

According to an exemplary embodiment, community water center 600 includes a plumbing system that may be pre-assembled within the inner volume of container 610. The plumbing system may include various pipes, fittings, and unions to join a plurality of outlet ports and inlet ports defined by container 610. By way of example, container 610 may define a primary water inlet port, a plurality of waste return ports, a plurality of water outlet ports, and a primary waste discharge port. According to an exemplary embodiment, the outlet ports and inlet ports are formed within the walls of container 610 during an initial manufacturing process thereby reducing the need for additional fabrication upon delivery of community water center 600. In some embodiments, a pump within the inner volume of container 610 flows water from a water source, through the primary water inlet port, through the plumbing system, and out through the water outlet ports.

Referring still to the exemplary embodiment shown in FIG. 9, community water center 600 includes a plurality of fixtures secured along the outer surface of container 610. According to an exemplary embodiment, such fixtures include a shower head, shown as shower head 620, a shower pan, shown as shower pan 621, toilets, shown as toilets 622, wash basins, shown as sinks 624, and spigots, shown as spigots 626. As shown in FIG. 9, shower head 620, toilets 622, sinks 624, and spigots 626 are in fluid communication with water outlet ports defined by container 610. According to an exemplary embodiment, shower pan 621, toilets 622, and sinks 624 are in fluid communication with waste return ports defined by container 610. While FIG. 9 shows a combination of fixtures, community water center 600 may include only shower heads 620 and shower pans 621; only toilets 622; only sinks 624; various combinations of shower heads 620 and shower pans 621, toilets 622, or sinks 624; or still other fixtures, according to various alternative embodiments. According to still another alternative embodiment, community water center 600 may include various fixtures secured along multiple sides of container 610.

In some embodiments, container 610 further includes a water heating system configured to increase the temperature of water flowed through the primary water inlet port. The water heating system may be in fluid communication with at least one of the various fixtures of community water center 600 (e.g., shower head 620, sinks 624, spigot 626, etc.) to provide heated water to a local community. As discussed above, Applicant has discovered that the availability of heated water may promote the use of community water center 600 and improve personal hygiene within a local community. In some embodiments, one spigot 626 may be configured to provide water having a temperature that is greater than water provided by another spigot 626. Visual indications (e.g., locking door 616 painted blue and locking door 617 painted red) may convey the difference between the two spigots to a local community.

According to the exemplary embodiment shown in FIG. 9, community water center 600 includes a water storage tank, shown as tank 630. Tank 630 may be provided within container 610 during transportation, attached to the outer surface of container 610 during transportation, shipped separately to a target location, or acquired locally at a target location. In some embodiments, tank 630 is in fluid communication with a pump and at least one fixture of community water center 600 thereby allowing the pump to flow water into tank 630 for storage prior to use. According to an exemplary embodiment, the storage of water within tank 630 reduces the need to operate a pump to create water pressure within the plumbing system. In some embodiments, such water pressure causes water to flow from the fixtures of community water center 600. According to an alternative embodiment, tank 630 may be used to store water heated as part of a water purification system until the temperature of the water decreases to a preferred level of 110 degrees Fahrenheit (43.3 degrees Celsius), 100 degrees Fahrenheit (37.8 degrees Celsius), 80 degrees Fahrenheit (26.7 degrees Celsius), or another temperature. In such embodiments, tank 630 may include a heat exchanger to preheat unpurified water with energy from the stored, purified water before the unpurified water enters the water purification system.

As shown in FIG. 9, tank 630 includes a water storage portion, shown as container 632 that is supported in an elevated position relative to the fixtures of community water center 600 by a plurality of structural members, shown as support system 634. In some embodiments, the elevated position of container 632 may allow the pump to periodically flow water into container 632 where the water may remain until a valve (e.g., a valve coupled to spigot 626) is opened. After the valve is opened, a gravity head pressure may flow water from container 632 into the inner volume of container 610 and through a water outlet port for use by a user. The use of a gravity feed may reduce the need to continuously operate a pump during use of the fixtures. In other embodiments, container 632 of tank 630 may be located at the same or a lower elevation as the fixtures.

Referring still to the exemplary embodiment shown in FIG. 9, community water center 600 may include a plurality of panels secured along the outer surface of container 610. Such a community water center 600 may utilize the structural characteristics of container 610 as the support for a larger assembly of components (e.g., panels, railings, fixtures, lights, etc.). In some embodiments, the various panels of community water center 600 may be provided initially in a disassembled configuration (e.g., positioned within the inner volume of container 610, shipped separately, provided by a technician or user, etc.) and assembled after deployment of container 610. As shown in FIG. 9, container 610 may define a plurality of interfaces configured to engage the panels. According to an exemplary embodiment, such interfaces include a plurality of apertures defined within the sidewalls of container 610 and configured to receive fasteners (e.g., rivets, bolts, etc.). In other embodiments, the interfaces include markings along the outer surface of container 610 configured to guide a technician in coupling (e.g., fastening, adhesively securing, etc.) the panels to container 610. Where the interfaces include apertures, community water center 600 may include caps to prevent material from entering container 610 during transportation.

As shown in FIG. 9, community water center 600 includes a plurality of sidewalls, shown as side panels 640, a roof panel, shown as upper panel 642, and dividing panels, shown as dividers 644. According to an exemplary embodiment, upper panel 642 includes a first end coupled to an upper portion of container 610 and an intermediate portion extending outward from container 610 toward a second end. For clarity, a portion of a side panel 640 and upper panel 642 are hidden in FIG. 9. In some embodiments, community water center 600 includes support beams, shown as supports 646, and railings, shown as railings 648. As shown in FIG. 9, supports 646 extend vertically from a first end that engages a ground surface (e.g., through a footing, etc.) toward a second end to structurally support various components of community water center 600.

According to an exemplary embodiment, the panels and support beams of community water center 600 form a partially enclosed space. As shown in FIG. 9, a first side panel 640 includes a first end coupled to container 610 and an intermediate portion extending toward a first support 646. A second side panel 640 includes a first end coupled to the first support 646, an intermediate portion, and a second end, which is coupled to a second support 646. The intermediate portion of side panel 640 may also be coupled to a third support 646. As shown in FIG. 9, railings 648 each include a first end coupled to container 610. Railings 648 extend laterally outward to a second end that is coupled to a support 646. According to an exemplary embodiment, the side panels 640 and the upper panel 642 define an internal area. As shown in FIG. 9, dividers 644 may subdivide the internal area to, by way of example, create stalls and provide at least partial privacy to the users of community water center 600. In some embodiments, dividers 644 include a first end coupled to container 610 and a second end extending into the internal area. The second end of dividers 644 may be supported (e.g., with a support beam) or may not be separately supported.

It should be understood that the configuration of panels, supports, and railings shown in FIG. 9 is intended to be illustrative of the various configurations of components that community water center 600 may include. According to an alternative embodiment, community water center 600 may include more or fewer side panels, supports, or still other components. According to still another alternative embodiment, community water center 600 may include dividers 644 but not side panels 640. Such a configuration may reduce the risk of vandalism to community water center 600, reduce the risk that criminal activity may occur, or otherwise encourage the use of community water center 600. In still another alternative embodiment, community water center 600 may not include dividers 644 to, by way of example, encourage use, reduce the risk of vandalism, or to improve security within community water center 600.

Referring still to the exemplary embodiment shown in FIG. 9, community water center 600 includes an energy storage system. In some embodiments, energy may be removed and subsequently replaced into the energy storage system. Such an energy storage system may comprise at least one of a propane storage tank, a natural gas storage tank, and a battery bank. As shown in FIG. 9, community water center 600 includes a plurality of solar panels, shown as solar panels 650 configured to be coupled to a battery bank. According to an exemplary embodiment, solar panels 650 are positioned on corresponding frames and secured to the top wall 612 of container 610 with a plurality of fasteners (e.g., rivets, bolts, screws, etc.). Such fasteners may have head portions positioned on the outside of container 610 and threaded portions that engage corresponding nuts within the inner volume of container 610 to, by way of example, reduce the risk of theft of solar panels 650. According to an alternative embodiment, community water center 600 may receive electrical energy from a local electrical grid or may include an electrical power generation system, such as a fossil fuel or biogas generator. In some embodiments, the electrical power generation system may supplement, replace, or provide redundancy for various primary electrical sources, such as solar panels 650.

According to an exemplary embodiment, energy from an energy storage system, an electrical power generation system, solar panels 650, a local electrical grid, or other source may power various components of community water center 600. By way of example, the energy may power the water pump configured to provide water to the interior volume of container 610. According to the exemplary embodiment shown in FIG. 9, the energy powers a plurality of lighting fixtures, shown as lights 660, configured to illuminate the area surrounding container 610. According to an exemplary embodiment, lights 660 comprise light emitting diodes thereby reducing the electrical power required to provide a preferred amount of illumination. According to an alternative embodiment, community water center 600 may provide auxiliary power outlets to power other devices (e.g., cellular telephones, radios, lights, etc.), a portion of the electrical energy produced by community water center 600 may be dedicated to external use, or community water center 600 may itself include additional devices powered by electrical energy. In some embodiments, the water heating and purification systems are supplied by independent electric power sources and may include at least one of a separate and an additional battery back-up system. Such an arrangement preserves the production of purified water even if the water heating system fails and may prevent contamination of the purified water by untreated water.

As shown in FIG. 9, community water center comprises a plurality of additional components including vents, shown as vents 670 and access stairs, shown as stairs 672. By way of example, vents 670 may provide for air circulation within the inner volume of container 610, and stairs 672 may provide access to top wall 612 of container 610 (e.g., for service or installation of solar panels 650 or upper panel 642, etc.).

While FIG. 9 shows a plurality of panels coupled to a single container 610, it should be understood that the modular design of community water center 600 facilitates the deployment of still other configurations. According to an alternative embodiment, a plurality of coordinating containers 610 may be deployed such that a first container includes a first set of features (e.g., a spigot delivering warm water, fixtures designated for use by men, only shower heads or another type of fixture, etc.) and a second container includes a second, coordinated set of features (e.g., a spigot delivering cold water, fixtures designated for use by women, only toilets or another type of fixture, etc.). According to another alternative embodiment, panels may extend between several containers to create an at least partially enclosed volume.

In still other embodiments, several containers may operate together to form the community water center. By way of example, a first container may include a large propane tank configured to deliver propane fuel to a water heater located within a second container. The community water center is capable of still other configurations where one or more containers may be deployed unilaterally or in a coordinated fashion.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present inventions. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A deployable water management unit, comprising:
a container having a plurality of walls that define an inner volume and an outer surface, wherein the plurality of walls further defines a water inlet port and a water outlet port;
a piping system disposed within the inner volume, the piping system defining a water flow path between the water inlet port and the water outlet port; and
a fixture configured to be secured along the outer surface of the container and in fluid communication with the water outlet port.

2. The unit of claim 1, wherein the plurality of walls further defines a waste return port and the fixture comprises a toilet configured to receive water from the water outlet port and flow effluent into the inner volume through the waste return port.

3. The unit of claim 1, further comprising a water heater positioned within the inner volume of the container and disposed along the water flow path between the water inlet port and the water outlet port, the water heater configured to increase the temperature of water received through the water inlet port to produce a heated water flow.

4. The unit of claim 1, further comprising a pump configured to flow water from a ground source through the water flow path.

5. The unit of claim 4, further comprising a water storage tank positioned along the water flow path, wherein the water storage tank is configured to receive water from the pump and provide water to the fixture through the water outlet port.

6. The unit of claim 5, wherein the pump is disposed within the inner volume along the water flow path.

7. The unit of claim 5, wherein the pump is configured to be positioned outside the container and includes a high-pressure side in fluid communication with the water inlet port.

8. A modular water purification system, comprising:
a container having a plurality of walls that define an inner volume and an outer surface, wherein the plurality of walls defines a water inlet port and a water outlet port;
a piping system disposed within the inner volume, the piping system defining a water flow path between the water inlet port and the water outlet port; and
a water purifier positioned within the inner volume of the container and disposed along the water flow path between the water inlet port and the water outlet port,
wherein the water purifier is configured to increase the temperature of water received through the water inlet port to a temperature of at least 73.9 degrees Celsius.

9. The system of claim 8, further comprising a tank coupled to the water purifier and the water outlet port with the piping system, wherein the tank is configured to allow the temperature of the water stored therein to decrease.

10. The system of claim 9, further comprising a fixture configured to be secured along the outer surface of the container and in fluid communication with the water outlet port.

11. The system of claim 10, wherein the fixture comprises a shower head.

12. The system of claim 10, wherein the fixture comprises a spigot.

13. The system of claim 8, further comprising an energy storage system disposed within the inner volume of the container, the energy storage system powering the water purifier.

14. The system of claim 13, wherein the energy storage system comprises at least one of a propane storage tank, a natural gas storage tank, and a battery bank.

15. The system of claim 14, wherein the water purifier comprises a tankless water heater.

16. A system for managing water to improve community health, comprising:
a container having a plurality of walls that define an inner volume and an outer surface, wherein the plurality of walls further defines a water inlet port and a water outlet port;
a piping system disposed within the inner volume, the piping system defining a water flow path between the water inlet port and the water outlet port;
a fixture configured to be secured along the outer surface of the container and in fluid communication with the water outlet port; and
a plurality of interfaces configured to couple a panel to the outer surface of the container.

17. The system of claim 16, further comprising a pillar configured to support the panel, the panel forming a partially enclosed space when supported by the pillar.

18. The system of claim 16, wherein at least one of the fixture and the panel is configured to be secured along the outer surface of the container with a plurality of fasteners extending through at least one of the plurality of walls and into the inner volume of the container.

19. The system of claim 18, wherein the plurality of fasteners comprise bolts having a head portion that interfaces with the fixture, a body portion extending through at least one of the plurality of walls, and a threaded portion positioned within the inner volume of the container.

20. The system of claim 16, further comprising a solar panel coupled to the outer surface of the container and a battery bank disposed within the inner volume of the container, wherein the solar panel is configured to charge the battery bank and the battery bank is configured to power at least one of a pump and a light.
